(19) United States
(12) Patent Application Publication
(10) Pub. No.: US 2009/0313020 A1
(43) Pub. Date: Dec. 17, 2009

(54) TEXT-TO-SPEECH USER INTERFACE CONTROL

(75) Inventor: Rami Arto Koivunen, Turku (FI)

Correspondence Address: Perman & Green, LLP, 99 Hawley Lane, Stratford, CT, 06614, US

(73) Assignee: Nokia Corporation, Espoo (FI)

(21) Appl. No.: 12/137,636

(22) Filed: Jun. 12, 2008

(51) Int. Cl. G10L 13/00

(52) U.S. Cl. 704/260; 704/E13.001

(57) ABSTRACT

A system and method includes a detecting computer readable text associated with a device, detecting a starting point for a text-to-speech conversion of text, beginning the text-to-speech conversion upon detection of movement of a pointing device in a direction of text flow, and controlling a rate of the text-to-speech conversion based on a rate of movement of the pointing device in relation to the text to be converted.

### BACKGROUND

1. Field

The aspects of the disclosed embodiments generally relate to text-to-speech systems and more particularly to a user interface for controlling the synthesis of automated speech from computer readable text.

2. Brief Description of Related Developments

In text-to-speech conversion systems, the selection of a particular segment of text to be converted into speech and the rate at which the text-to-speech conversion should occur can be difficult to control. This can be especially true if the user is visually impaired or is not able to easily visualize the text that is to be read. Typically, one controls the start of the text-to-speech conversion process and the computer reads the sentence or paragraph. In a situation where there is a great deal of text, it can be difficult to locate or control a beginning point for the text-to-speech conversion process. For example, if a newspaper page is open on a display of a computer, the user may not wish to have the entire article read-out, but only desire to have a portion of a particular article read. Finding such a starting position can be difficult without good control over what actually will be read. This can be especially problematic in devices that have limited or small screen or display areas.

The current development of touch screen devices has enabled one to better control the positioning and the location of a cursor on the screen of such a device. As the term is used herein, “cursor” is generally intended to encompass a moving placement or pointer that indicates a position. The use of the mouse style device generally does not provide the same ease of positioning a cursor or identifying a selection point on the screen, as does a touch screen.

It would be advantageous to be able to easily select a particular position in computer readable text from which a text-to-speech conversion process should begin. It would also be advantageous to be able to easily alter the speed of the text-to-speech conversion process and readback.

### SUMMARY

The aspects of the disclosed embodiments are directed to at least a method, apparatus, user interface and computer program product. In one embodiment the method includes detecting computer readable text, detecting a starting point for a text-to-speech conversion of the text, beginning the text-to-speech conversion upon detection of movement of a pointing device in a direction of text flow, and controlling a rate of the text-to-speech conversion based on a rate of movement of the pointing device in relation to the text to be converted.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates an example of an application of the disclosed embodiments;

FIGS. 3A and 3B illustrates exemplary device applications of the disclosed embodiments;

FIG. 4 illustrates an example of a process incorporating aspects of the disclosed embodiments;

FIG. 5 illustrates a block diagram of the architecture of an exemplary user interface incorporating aspects of the disclosed embodiments;

FIGS. 6A and 6B are illustrations of exemplary devices that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the devices of FIGS. 6A and 6B may be used.

### DETAILED DESCRIPTION OF THE EMBODIMENT(s)

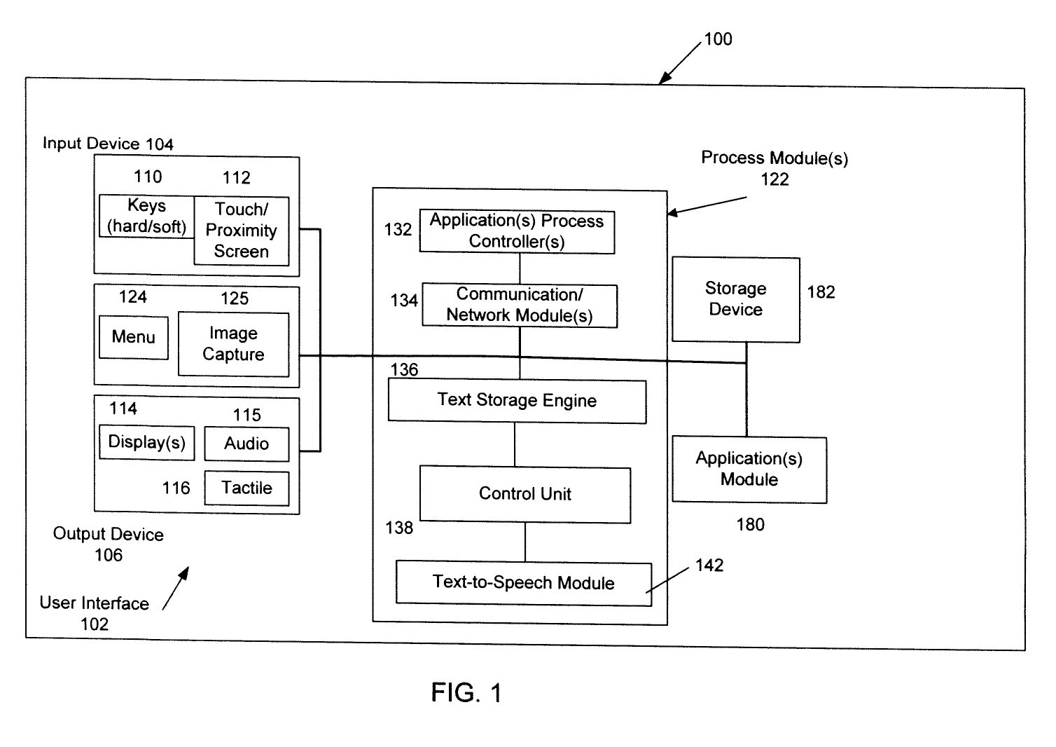

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally allow a user to select a precise point from which to begin a text-to-speech conversion process in order to generate automated speech from computer readable or understandable text. While computer readable text is displayed on a screen of a device the user can select any point within the text portion or area from which to start the text-to-speech conversion process. Although the aspects of the disclosed embodiments will generally be described herein with relation to text displayed on a screen of a device, the scope of the disclosed embodiments is not so limited. In one embodiment, the aspects disclosed herein can be applied to a device that does not include a display, or a device configured for a user who is visually impaired. For example, in one embodiment, the aspects of the disclosed embodiments can be practiced on a touch device that does not include a display. The computer readable text can be associated with internal coordinates that are known or can be determined by the user. The user can input or select the coordinate(s) for beginning a text-to-speech conversion process on computer readable text, rather than selecting a point from text being displayed.

The text-to-speech conversion process does not need to start from a beginning of the text or segment thereof. Any intermediate position within the displayed text can be chosen. In one embodiment, a whole or complete word that is nearest the selection point or point of contact can be chosen or selected as the starting point. If the selection point is within a word, that word can be chosen as the starting point. In one embodiment, the text-to-speech conversion process can begin from within a word. If the selected starting point is in-between words, or not precisely at a word, the nearest whole word or text can be selected. For example, the selection criterion can be to select the next word. In alternate embodiments, any suitable criterion can be used to select the starting point when the selected point is in a portion of a word or in-between words. The selection criterion can be configured in a settings menu of the device or application. In one embodiment, the word that is selected as the starting point for text-to-speech conversion can be highlighted. In the embodiment of a device that does not include a display, the starting point can be verbally identified. The aspects of the disclosed embodiments allow a user to easily control and locate from where or what position the text-to-speech conversion process should start.

Once the text-to-speech conversion process begins, the user can control or adjust a rate of the text-to-speech conversion process by controlling the rate of movement of the pointing device with respect to the text to be converted. In an embodiment where the device does not include a display, or the user cannot perceive the display, movement of the pointing device in a designated region, such as a text-to-speech control region, of the device can be used to control the rate of the text-to-speech conversion process. In one embodiment, the text-to-speech control region does not have to be on the device itself. The pointing device can be configured determine a rate of its movement across any surface. For example, in an embodiment where the pointing device is an optical cursor or mouse, the pointing device can detect its movement over the surface it is on, such as a mousepad. The relative rate of movement of the point device can be determined from this detected movement. In another embodiment, the pointing device comprises a cursor that is controlled by a cursor control device, such as for example, the up/down/left/right arrow keys of keyboard, a joystick, mouse, or other such controller. The user can move the cursor to the text-to-speech control region and control the rate of movement by, for example, moving the cursor within the region. Movement of the cursor can be executed or controlled in any suitable manner, such as by using the arrow or other control keys of a keyboard or mouse device.

The user can move the pointing device faster or slower so the text can be read out more slowly or faster than a normal or default rate or setting for the text-to-speech conversion process. In one embodiment, if the pointer is removed from the screen or other text-to-speech control region, the text-to-speech conversion process or “reading” can continue at the default rate of the device or system. The default rate can be one that is pre-set in the system or adjustable by the user.

When the pointer is removed from the screen, in one embodiment, the text-to-speech conversion process can continue to an end-of-text indicator or other suitable text endpoint. An end-of-text indicator can be any suitable indication that a natural end of a text segment has been reached. For example, in one embodiment, an end-of-text indicator can include a punctuation mark, such as a period, question mark or exclamation point. In an alternate embodiment, an end-of-text indicator can comprise any suitable grammatical structure, such as a carriage or line return, or a new paragraph indication. Thus, once the pointer is removed from the screen of the device, the text-to-speech conversion process can continue to an end of a sentence or paragraph.

In one embodiment, after the pointer is removed from the screen, the user can also re-establish contact of the pointer with the text on the screen. In one embodiment, if the text-to-speech conversion process has not stopped, the text-to-speech conversion process can continue to the new point of contact. If the new point of contact is not close to a current reading position (the current point of the text-to-speech conversion), or is prior to the current reading position, the text-to-speech conversion process can jump forward or back to the new point of contact. For example, it can be determined whether the new point of contact exceeds a pre-determined interval from the current reading point. When a new point of contact is detected, the distance or interval between the new point of contact and the current reading position is determined. In one embodiment, the pre-determined interval or “distance” can comprise the number of characters or words between the two positions. In alternate embodiments, any suitable measure of distance can be utilized, including for example, a number of lines between the two points. The “pre-determined interval” comprises a pre-set distance value. If the pre-determined interval is exceeded, in one embodiment, the text-to-speech conversion process can “jump” to this new point and resume reading from this point in accordance with the disclosed embodiments. This allows the user to “jump” forward or over text.

If the new position is prior to the current reading position, the text-to-conversion process can “jump” back to the prior position. This allows a user to “repeat” or go back over a portion of text using the pointer.

Referring to FIG. 1, the system 100 of the disclosed embodiments can generally include input device(s) 104, output device(s) 106, process module 122, applications module 180, and storage/memory device(s) 182. The components described herein are merely exemplary and are not intended to encompass all components that can be included in the system 100. The system 100 can also include one or more processors or computer program products to execute the processes, methods, sequences, algorithms and instructions described herein.

The input device(s) 104 are generally configured to allow a user to input data, instructions and commands to the system 100. In one embodiment, the input device 104 can be configured to receive input commands remotely or from another device that is not local to the system 100. The input device 104 can include devices such as, for example, keys 110, touch screen 112, menu 124, an imaging device 125, such as a camera or such other image capturing system. In alternate embodiments the input device can comprise any suitable device(s) or means that allows or provides for the input and capture of data, information and/or instructions to a device, as described herein. The output device(s) 106 are configured to allow information and data to be presented via the user interface 102 of the system 100 and can include one or more devices such as, for example, a display 114 (which can be part of or include touch screen 112), audio device 115 or tactile output device 116. In one embodiment, the output device 106 can be configured to transmit output information to another device, which can be remote from the system 100. While the input device 104 and output device 106 are shown as separate devices, in one embodiment, the input device 104 and output device 106 can be combined into a single device, and be part of and form, the user interface 102. The user interface 102 of the disclosed embodiments can be used to control a text-to-speech conversion process. While certain devices are shown in FIG. 1, the scope of the disclosed embodiments is not limited by any one or more of these devices, and an exemplary embodiment can include, or exclude, one or more devices. For example, in one exemplary embodiment, the system 100 may only provide a limited display, or no display at all. A headset can be used as part of both the input devices 104 and output devices 106.

The process module 122 is generally configured to execute the processes and methods of the disclosed embodiments. The application process controller 132 can be configured to interface with the applications module 180, for example, and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers and maps. In alternate embodiments, the applications module 180 can include any suitable application. The communication module 134 shown in FIG. 1 is generally configured to allow the device to receive and send communications and messages, such as text messages, chat messages, multimedia messages, video and email, for example. The communication module 134 is also configured to receive information, data and communications from other devices and systems.

In one embodiment, the process module 122 includes a text storage module or engine 136. The text storage module 136 can be configured to receive and store the computer understandable or readable text that is to be displayed on a display of the device 100. The text storage module 136 can also store the location or coordinates of the relative text position within the document. These coordinates can be used to identify the location of the text within a document, particularly in a situation where the device does not include a display.

The process module 122 can also include a control unit or module 138 that is configured to provide the computer readable text to the screen of the display 114. In an embodiment where the device does not include a display, the control unit 138 can be configured to associate internal coordinates with the computer readable text and make the coordinate data available.

In one embodiment the control unit 138 can also be configured to control the text-to-speech conversion module 142 by providing the location, with respect to the text being displayed on the screen, from which to begin the text-to-speech conversion process. The control unit 138 can also control the rate of the text-to-speech conversion process by monitoring the rate of movement of the pointer with respect to the text to be converted and providing a corresponding rate control signal to the text-to-speech module 142.

The text-to-speech module 142 is generally configured to synthesize computer readable text into speech and change the speed of the text-to-speech read out. In one embodiment, the text-to-speech module 142 is a plug-in device or module that can be adapted for use in the system 100.

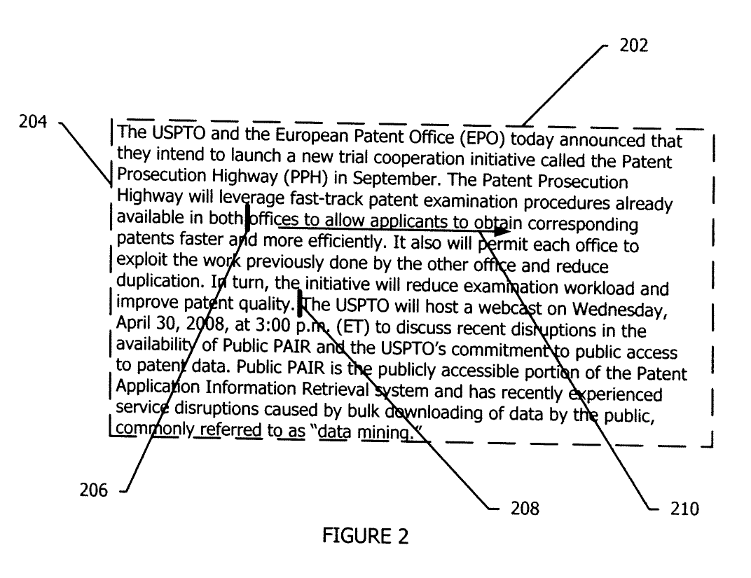

The aspects of the disclosed embodiments allow a user to begin the text-to-speech conversion process from any point within text that is being displayed on a screen of a device and to control the rate of the text-to-speech conversion process based on a rate of movement of a pointing device over the text to be converted. For example referring to FIG. 2, a page of computer understandable or readable text 204 is displayed or presented on a display 202. In one embodiment, the user positions the pointing device or cursor at or near position 206 within the text from which or where the user would like the text-to-speech conversion process to begin. The position selected can be anywhere within or on the page 204. If the position 206 coincides with a word, the text-to-speech conversion process can start with that word. If the position is near or between words, such as position 206, in one embodiment, the closest word is selected. In one embodiment, the text-to-speech conversion process can be configured to start from the beginning of the sentence that includes the selected word.

In this example, the word “offices” is closest to the selected position 206. In one embodiment, the determination of the “closest” word can be configurable by the user, and any suitable criteria can be used. For example, in one embodiment, if the selected position 206 is between two words, the “next” word following the selected position can be used as the starting position. As another example, if the selected position is near the end of a sentence, the starting position can be the beginning of that sentence. This type of selection can be advantageous where screen or display size is limited and accuracy to a word level is not precise or difficult.

Once the starting position is selected, the user can then begin to move the pointing device in the direction 210 of the text flow, or reading order, to start the text-to-speech conversion process. In one embodiment, the rate of the text-to-speech conversion process depends on the speed with which the user moves the pointing device over the text in the direction 210 of the text flow. In an alternate embodiment, the text-to-speech conversion process proceeds at the default rate. If the user removes the pointing device from the screen 202 the text-to-speech conversion process can continue to an endpoint of the text or other stopping point. In one embodiment, the rate of the text-to-speech conversion process reverts to and/or continues at the default rate after the pointing device is removed from the screen.

In one embodiment, to stop or end the text-to-speech conversion process, the user can stop, halt or hold the pointing device at a desired stop position 208. Alternatively, a sequence of tapping of the pointing device at a particular position can be used to stop the text-to-speech conversion. For example, tapping twice can provide a signal to stop the text-to-speech conversion process at the current reading position. To resume the text-to-speech conversion process, another sequence of one or more taps may be used. In alternate embodiments, any suitable sequence of taps or movement of the pointing device can be used to provide stop and resume commands. For example, in one embodiment, after the text-to-speech conversion process has been stopped, movement of the pointing device over text on the display can resume the text-to-speech conversion process.

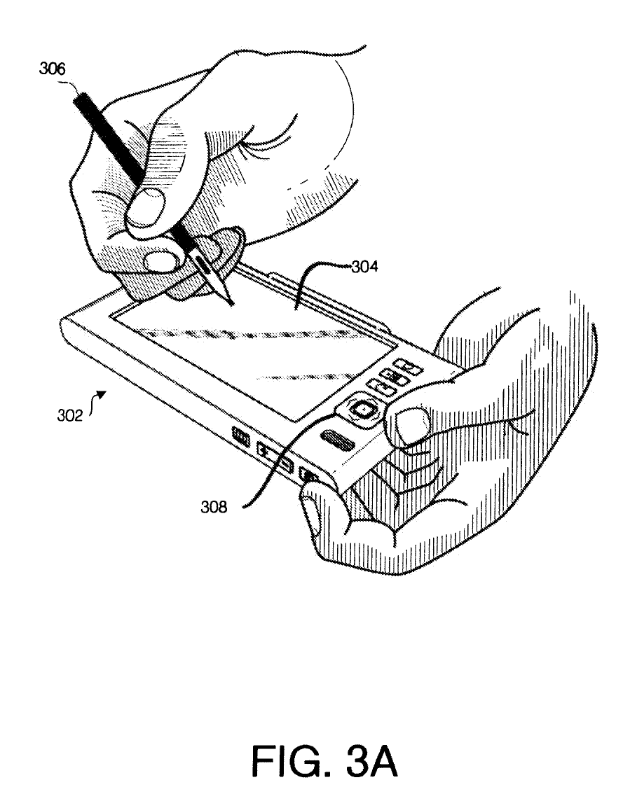

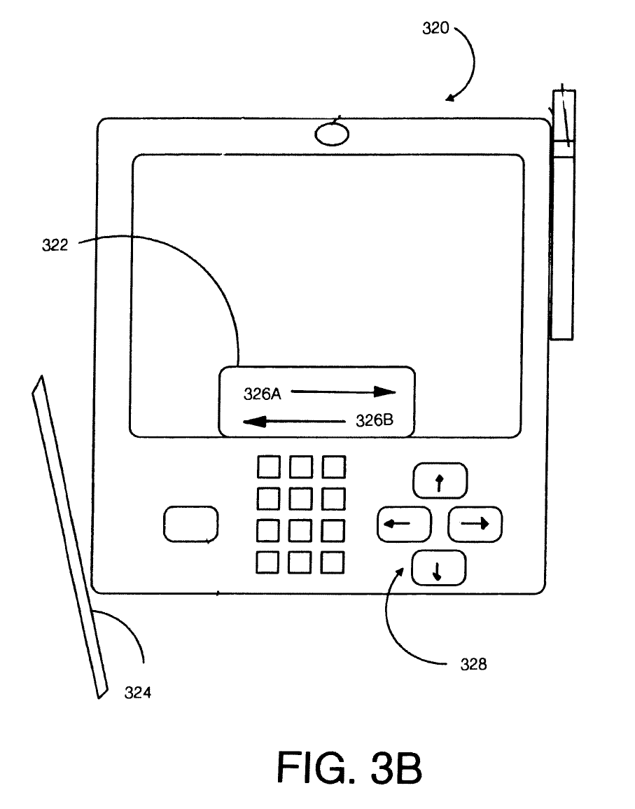

Referring to FIG. 3A, the aspects of the disclosed embodiments can be executed on the device 302 that includes a touch screen display 304. A pointing device 306 can be used to provide input signals, such as marking the position on the screen 304 from where the text-to-speech conversion process should start. Moving the pointing device 306 over the text in the direction of the text flow can allow the user to continuously select text to be converted as well as to adjust the rate with which the text-to-speech conversion process is carried out, as is described herein. Although the example in FIG. 3A shows a stylus type device being used as the pointing device 306, it will be understood that any suitable device that is compatible with a touch screen display can be used. In alternate embodiments, such as where the device does not include a touch screen display, any suitable pointing device or cursor control device can be used including for example, a mouse style cursor, trackball, arrow keys of a keyboard, touchpad control device or joystick control. For example, the control 308 in FIG. 3A, which in one embodiment comprises a cursor control device, could be used to position the cursor or pointing device. In an exemplary embodiment, the user's finger can be the pointing device 306. The user can point to a position on the screen, which will mark the starting point for the text-to-speech conversion process.

As the user begins to move their finger (or other pointing device) in a direction of the text flow, the text-to-speech conversion process will commence. If the finger is removed from the touch surface or screen, the text-to-speech conversion process will continue from the point where the finger left the screen, or the loss of contact was detected. If the finger moves continuously over the surface of the touch screen, the rate of text-to-speech conversion process will be dependent upon the speed of the finger. In one embodiment, a tap of the finger on the screen can stop the text-to-speech conversion process, while another tap can resume the text-to-speech conversion process. Where a joystick or arrow control is used, activation of a center key, or other suitable key, for example, can be used as the stop/resume control.

In one embodiment, the user moves or runs the pointing device or finger over the text on the screen to adjust the rate of the text-to-speech conversion. In an alternate embodiment, the user can run the finger, or other pointing device, over any suitable area on the screen of the device to control or adjust the rate. For example, the user removes the pointing device from the screen and the text-to-speech conversion process continues as described herein. In one embodiment, the user can use the pointer to select or touch another area of the screen, such as a non-text area, that is designated as a rate control area. The movement of the pointing device along the rate control area of the screen can be used to control the rate of the text-to-speech conversion process. For example, in one embodiment, the movement of the pointing device along a non-text area or border region that is designated as a rate control area would be detected and used to adjust the rate.

For example, referring to FIG. 3B., the device 320 includes a rate control area or region 322 that can be used to control or adjust the text-to-speech conversion rate. The user selects the starting point for the text-to-speech conversion process as described herein. Movement of the pointing device in the direction of the text flow begins the text-to-speech conversion process. Once the text-to-speech conversion process has started, in one embodiment, movement of the pointing device 324 or finger in a left-to-right direction 326A in the rate control area can increase the rate. Movement of the pointing device 324 or finger in a right-to-left direction 326B in the rate control area can decrease the rate. Alternatively, up/down directional movement can also be used to control the rate. Holding a substantially stationary position within the region 322 can be used to slow and/or stop the text-to-speech conversion process. Alternatively, the scroll buttons or keys 328 can be used to control the text-to-speech conversion rate.

In one embodiment, filtering can be applied to smoothen the spoken words. Since the cursor can select any point within the text area as the starting point for the text-to-speech conversion process, or “jump” within the text during text-to-speech conversion, the converted text may need to be compensated or filtered prior to being outputted in order to provide the proper inflection.

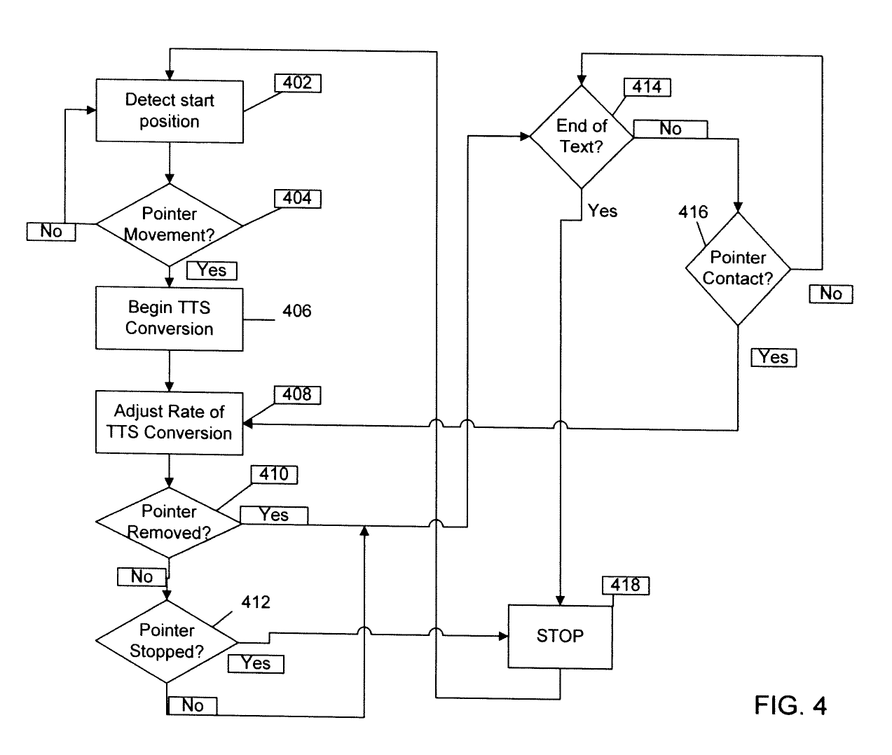

Referring to FIG. 4, one example of an exemplary process incorporating aspects of the disclosed embodiments is illustrated. A start position for the text-to-speech conversion process is detected 402. In one embodiment this comprises contacting a touch screen at a point within or near a section of text displayed on the screen. In an alternate embodiment where the device does not include a display, selecting a start position can include activating a text-to-speech control region, identifying a present location of a cursor with the computer readable text, and moving the cursor to a desired start position. For example, the text-to-speech control region is activated. The device outputs, via speech, the location of the cursor. The location can be selected as the start position or the cursor can be moved to another location.

In one embodiment, it is determined 404 whether any movement of the pointer in a direction of the text flow on the screen is detected. When movement of the pointer in the direction of the text flow is not detected, the text-to-speech conversion process does not start. A detection of the movement of the pointer in a direction of the text flow will start 406 the text-to-speech conversion process. The rate of text-to-speech conversion is adjusted 408 based on a detection of continuous movement of the pointer. If the pointer is removed 410 from the screen, the text-to-speech conversion process continues at a default rate until the end of the text 414 or other stop signal is received. If the pointer is not removed, the text-to-speech conversion process continues at a rate according to the rate of movement of the pointer until it is detected that the movement of the pointer is stopped 412 or the end of the text 414 is reached. If the end of text 414 is not reached and pointer contact 416 is again detected with the screen, the text-to-speech conversion rate can be adjusted based on the rate of movement of the pointer.

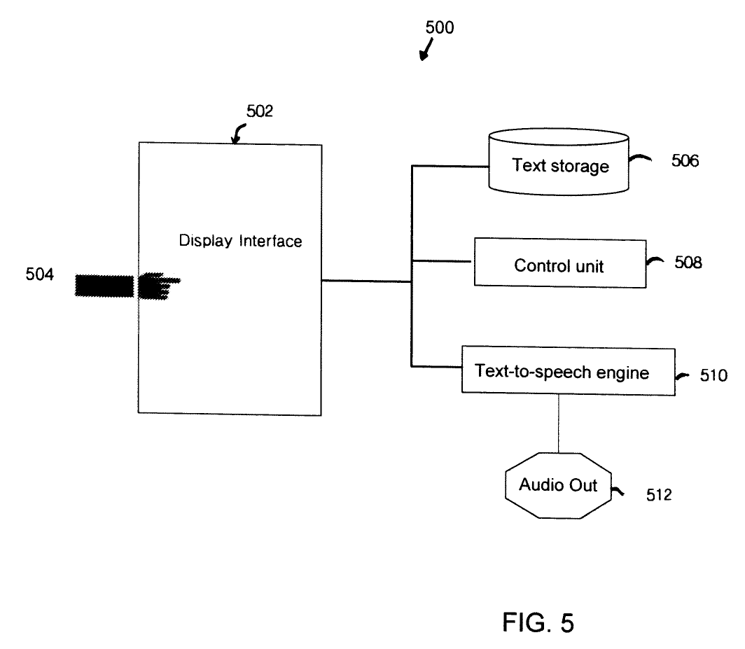

FIG. 5 illustrates an embodiment of an exemplary text-to-speech user interface system. In one embodiment, the user interface system 500 includes a display interface device 502, such as a touch screen display. In alternate embodiments, the display interface device 502 comprises a user interface for a visually impaired user, that does not necessarily present the text on a display so that it can be viewed, but allows the user to provide inputs and receive feedback for the selection of the text to be converted into speech in accordance with the embodiments described herein. A pointing device or pointer 504, which in one embodiment can comprise a stylus or the user's finger, is used to provide input to the display interface device 502. A text storage device 506 is used to store computer readable text that can be converted into speech. A control unit 508 is used to provide the computer readable text from the text storage device 506 to the display interface device for presentation or display. The control unit 508 can also provide a starting location for the text-to-speech conversion process to the text-to-speech engine 510 based on an input command. In one embodiment, the control unit 508 receives inputs from the display interface device 502 as to the position and movement of the pointer 504 in order to set or adjust a rate of the text-to-speech conversion, based on the movement of the pointer 504. An audio output device 512, such as for example a loudspeaker or headset device, can be used to output the speech that results from the text-to-speech conversion process. In one embodiment, the audio output device 512 can be located remotely from the other user interface 500 elements and can be coupled to the text-to-speech engine 510 and control unit 508 in any suitable manner. For example, a wireless connection can be used to couple the audio output device 512 to the other elements of the system 500 for suitable output of the audio resulting from the text-to-speech conversion process.

Referring to FIG. 1, in one embodiment, the user interface of the disclosed embodiments can be implemented on or in a device that includes a touch screen display 112, proximity screen device or other graphical user interface. In one embodiment, the display 112 can be integral to the system 100. In alternate embodiments the display may be a peripheral display connected or coupled to the system 100. A pointing device, such as for example, a stylus, pen or simply the user's finger may be used with the display 112. In alternate embodiments any suitable pointing device may be used. In other embodiments, the display may be any suitable display, such as for example a flat display that is typically made of a liquid crystal display (LCD) with optional back lighting, such as a thin film transistor (TFT) matrix capable of displaying color images. Although display 114 of FIG. 1 is shown as being associated with output device 106, in one embodiment, the displays 112 and 114 form a single display unit.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information, such as text, on the screen of the device. Thus, the above noted terms are intended to include that a user only needs to be within the proximity of the device to carry out the desired function. It should also be understood that arrow keys on a keyboard, mouse style devices and other cursors can be used as pointing device and to move a pointer.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity displays or screens, where navigation on the display and menus of the various applications is performed through, for example, keys 110 of the system or through voice commands via voice recognition features of the system.

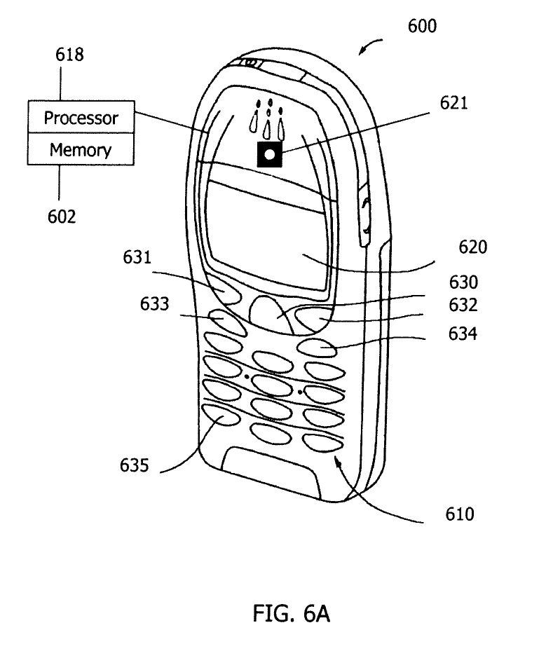

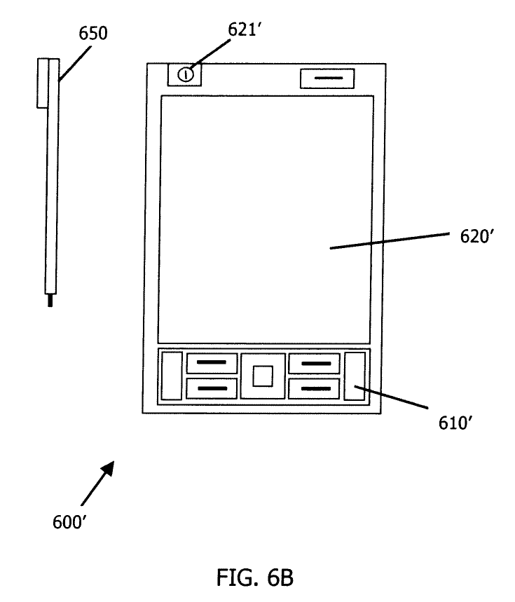

Some examples of devices on which aspects of the disclosed embodiments can be practiced are illustrated with respect to FIGS. 6A-6B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting and controlling the functions and commands described herein, and a scroll key function can be used to move to and select item(s), such as text.

As shown in FIG. 6A, in one embodiment, the device 600, which in one embodiment comprises a mobile communication device or terminal may have a keypad 610 as an input device and a display 620 for an output device. In one embodiment, the keypad 610 forms part of the display unit 620. The keypad 610 may include any suitable user input devices such as, for example, a multi-function/scroll key 630, soft keys 631, 632, a call key 633, an end call key 634 and alphanumeric keys 635. In one embodiment, the device 600 includes an image capture device such as a camera 621, as a further input device. The display 620 may be any suitable display, such as for example, a touch screen display or graphical user interface. The display may be integral to the device 600 or the display may be a peripheral display connected or coupled to the device 600. A pointing device, such as for example, a stylus, pen or simply the user's finger may be used in conjunction with the display 620 for cursor movement, menu selection, text selection and other input and commands. In alternate embodiments, any suitable pointing or touch device may be used. In other alternate embodiments, the display may be a conventional display. The device 600 may also include other suitable features such as, for example a loud speaker, headset, tactile feedback devices or connectivity port. The mobile communications device may have at least one processor 618 connected or coupled to the display for processing user inputs and displaying information and links on the display 620, as well as carrying out the method steps described herein. At least one memory device 602 may be connected or coupled to the processor 618 for storing any suitable information, data, settings and/or applications associated with the mobile communications device 600.

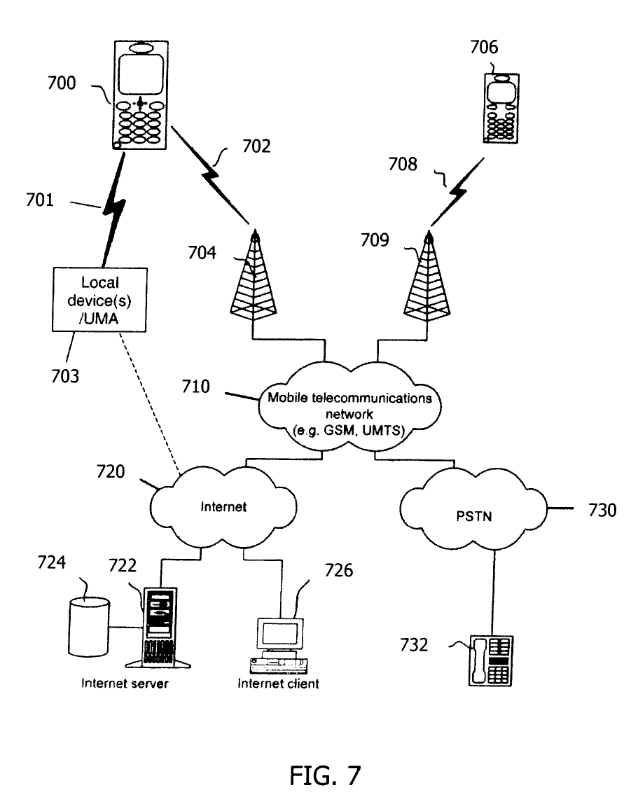

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 700 and other devices, such as another mobile terminal 706, a line telephone 732, a computing device 726 and/or an internet server 722.

In one embodiment the system is configured to enable any one or combination of chat messaging, instant messaging, text messaging and/or electronic mail, and the text-to-speech conversion process described herein can be applied to the computer understandable text in such messages and/or communications. It is to be noted that for different embodiments of the mobile device or terminal 700, and in different situations, some of the telecommunications services indicated above may or may not be available. The aspects of the disclosed embodiments are not limited to any particular set of services or communication system, protocol or language in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide area network 720, which may be the Internet or a part thereof. An Internet server 722 has data storage 724 and is connected to the wide area network 720, as is an Internet client 726. The server 722 may host a worldwide web/wireless application protocol server capable of serving worldwide web/wireless application protocol content to the mobile terminal 700.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local links 701 may be any suitable type of link or piconet with a limited range, such as for example Bluetooth™, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting, and any suitable type of link or short range communication protocol may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 includes communications module 134 that is configured to interact with, and communicate to/from, the system described with respect to FIG. 7.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 600′ illustrated in FIG. 6B. The personal digital assistant 600′ may have a keypad 610′, a touch screen display 620′, camera 621′ and a pointing device 650 for use on the touch screen display 620′. In still other alternate embodiments, the device may be a personal computer, a tablet computer, touch pad device, Internet tablet, a laptop or desktop computer, a mobile terminal, a cellular/mobile phone, a multimedia device, a personal communicator, a television or television set top box, a digital video/versatile disk (DVD) or High Definition player or any other suitable device capable of containing for example a display 114 shown in FIG. 1, and supported electronics such as the processor 618 and memory 602 of FIG. 6A. In one embodiment, these devices will be Internet enabled and can include map and global positioning system (“GPS”) capability.

The user interface 102 of FIG. 1 can also include menu systems 124 coupled to the processing module 122 for allowing user input and commands. The processing module 122 provides for the control of certain processes of the system 100 including, but not limited to, the controls for selecting files and objects, establishing and selecting search and relationship criteria, navigating among the search results, identifying computer readable text, detecting commands for start and end points of the text-to-speech conversion process and detecting control movement to determine text-to-speech conversion rates. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages, notifications, start and stop points and state change requests. Depending on the inputs, the process module 122 interprets the commands and directs the applications process control 132 to execute the commands accordingly in conjunction with the other modules.

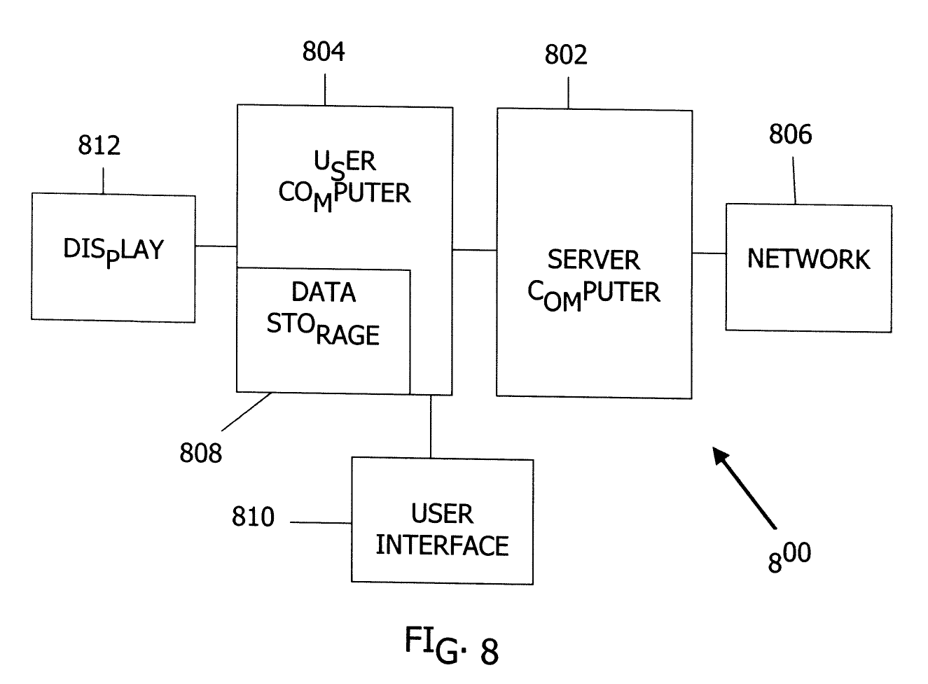

The disclosed embodiments may also include software and computer programs incorporating the process steps and instructions described above. In one embodiment, the programs incorporating the process steps described herein can be executed in one or more computers. FIG. 8 is a block diagram of one embodiment of a typical apparatus 800 incorporating features that may be used to practice aspects of the invention. The apparatus 800 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 800. The memory can be direct coupled or wireless coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Alternatively, where only one computer system is used, such as computer 804, computer 804 will be configured to communicate with and interact with the network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or other suitable connection or line, communication channel or link. In one embodiment, the communication channel comprises a suitable broad-band communication channel. Computers 802 and 804 are generally adapted to utilize program storage devices embodying machine-readable program source code, which is adapted to cause the computers 802 and 804 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the disclosed embodiments may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries, as described with reference to FIG. 1, for example.

The aspects of the disclosed embodiments allow a user to easily control where a text-to-speech conversion process should begin from within the text. The start position can easily and intuitively be located by, for example, pointing at the location on the screen. This enables to the user to browse or scroll through larger volumes of text in order to find a desired starting point within the text. The movement of the finger, or other pointing device can be used to control the rate of the text-to-speech conversion process. This allows the user to have the device read out text more slowly or faster than the default rate. Since it is easier to identify a place in the text where the text-to-speech conversion process should begin, it is also possible to sample text in different positions on the page simply by moving a pointing device or finger. The reading of the text can be started and stopped by the movement of the pointing device. The aspects of the disclosed embodiments allow the text-to-speech conversion process to be intuitively controlled. It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting a starting point for text-to-speech conversion of computer readable text associated with a device;
detecting a movement of a pointing device in a direction of text flow on a user interface region of the device to start the text-to-speech conversion; and
controlling a rate of the text-to-speech conversion based on a rate of the movement of the pointing device.

2. The method of claim 1 further comprising adjusting the rate of the text-to-speech conversion to correspond to the rate of movement of the pointing device in the direction of text flow.

3. The method of claim 1 further comprising continuing the text-to-speech conversion until a stop signal is detected.

4. The method of claim 3 wherein the stop signal is an end-of text signal or a user generated signal.

5. The method of claim 3 wherein the stop signal comprises detecting at least one tap signal on the user interface region of the device.

6. The method of claim 1 further comprising detecting that movement of the pointing device on the user interface region is stopped, and pausing the text-to-speech conversion at a position in the text corresponding to the position where the pointing device is stopped.

7. The method of claim 1 further comprising detecting removal of the pointing device from substantial contact with the user interface region and continuing the text-to-speech conversion at a rate corresponding to a default text-to-speech conversion rate.

8. The method of claim 7 further comprising:
detecting a new position of contact of the pointing device on the user interface region;
determining that the new position exceeds a pre-determined interval from a current point of the text-to-speech conversion process;
stopping the text-to-speech conversion process; and
resuming the text-to-speech conversion from the new position of contact when the pointing device begins to move in the direction of text flow from the new position.

9. The method of claim 7 further comprising:
detecting a new position of contact of the pointing device on the user interface region,
detecting if the pointing device is moved in a direction of text flow from the new position of contact; and
if movement is detected, adjusting the rate of the text-to-speech conversion to correspond to a current rate of movement of the pointing device, or
if movement is not detected, stopping the text-to-speech conversion at a position within the text corresponding to the new position of contact.

10. An apparatus comprising:
a command input module;
a text storage module configured to store computer readable text;
a control unit configured to associate location coordinates of the computer readable text with the command input module;
a text-to-speech converter configured to convert text that is designated by the command input module;
wherein the control unit is further configured to:
determine a starting location for a text-to-speech conversion process;
provide text to be converted to the text-to-speech converter when the text-to-speech conversion process commences; and
provide a rate of the text-to-speech conversion process to the text-to-speech converter based upon a rate of movement of a pointing device on the command input module.

11. The apparatus of claim 10 further comprising that the control unit is configured to determine that the starting location for the text-to-speech conversion is a location of the pointing device on the command input module.

12. The apparatus of claim 11 further comprising that the control unit is configured to determine that the text-to-speech conversion process commences upon detection of movement of the pointing device from the starting location in a direction of text flow on the command input module.

13. The apparatus of claim 11 further comprising that the control unit is configured to detect that the pointing device is no longer moving across the text to be converted and stop the text-to-speech conversion at a stopped location of the pointing device.

14. A user interface comprising:
a device configured to detect a selection of computer readable text for text-to-speech conversion; and
a processing device configured to:
detect a starting point for the text-to-speech conversion of the selected text;
begin the text-to-speech conversion when movement of a pointing device is detected in a direction of text flow on the display;
control a rate of the text-to-speech conversion, wherein the rate of text-to-speech conversion corresponds to a detected rate of movement of the pointing device in relation to the direction of the text flow; and
output a result of the text-to-speech conversion.

15. The user interface of claim 14 further comprising a text-to-speech rate adjustment region on the device, wherein the processor is configured to adjust the rate of the text-to-speech conversion to correspond to the detected rate and direction of movement of the pointer in the text-to-speech rate adjustment region.

16. The user interface of claim 15 wherein the text-to-speech rate adjustment region comprises a region beginning at the starting point for the text-to-speech conversion and extending along the text in the direction of the text flow.

17. The user interface of claim 15 wherein the text-to-speech rate adjustment region comprises a region that is adjacent to a text region of the device.

18. A computer program product comprising:
a computer useable medium stored in a memory having computer readable code means embodied therein for causing a computer to convert text-to-speech, the computer readable code means in the computer program product comprising:
computer readable program code means for causing a computer to detect a starting point for text-to-speech conversion of computer readable text;
computer readable program code means for causing a computer to detect a movement of a pointing device in a direction of text flow to start the text-to-speech conversion; and
computer readable program code means for causing a computer to control a rate of the text-to-speech conversion based on a rate of the movement of the pointing device.

19. The computer program product of claim 18 further comprising computer readable program code means for causing a computer to adjust the rate of the text-to-speech conversion to correspond to the rate of movement of the pointing device in the direction of text flow.
